(19) United States
(12) Patent Application Publication
(10) Pub. No.: US 2022/0215292 A1
(43) Pub. Date: Jul. 7, 2022

(54) METHOD TO IDENTIFY INCORRECT ACCOUNT NUMBERS

(71) Applicant: INTUIT INC., Mountain View, CA (US)

(72) Inventors: Tom JACOBE, Hod Hasharon (IL); Ori WAINSHTEIN, Hod Hasharon (IL); Ido Meir MINTZ, Tel Aviv (IL)

(21) Appl. No.: 17/656,103

(22) Filed: Mar. 23, 2022

Related U.S. Application Data
(63) Continuation of application No. 16/052,086, filed on Aug. 1, 2018.

(51) Int. Cl. G06N 20/00; G06F 9/46; G06Q 40/02; G06K 9/62

(52) U.S. Cl. CPC G06N 20/00; G06F 9/46; G06F 16/1865; G06K 9/6263; G06Q 40/02

(57) ABSTRACT

Certain aspects of the present disclosure provide techniques for identifying incorrect account numbers using machine learning. One example method includes receiving, over a network from a user device, a transaction including an account number and providing the account number to a machine learning model. The method further includes obtaining output from the machine learning model including a confidence score for the account number and transmitting, over the network to the user device, the confidence score. The method further includes receiving, over the network from the user device, a response to transmitting the confidence score and processing the transaction based on the response. The method further includes updating a transaction database based on success or failure of the transaction.

### CROSS-REFERENCE TO RELATED APPLICATIONS

This Application is a continuation of co-pending U.S. patent application Ser. No. 16/052,086, filed Aug. 1, 2018, the contents of which are incorporated herein by reference in their entirety.

### INTRODUCTION

Aspects of the present disclosure relate to pattern recognition using machine learning.

As computing devices, including mobile phones and other portable computing devices, continue to become more widespread, certain activities and functions are performed more frequently by computing devices. Some financial transactions that may have been performed manually are now conducted automatically using computing devices. For example, purchases may now be completed by entering the information of a check into a computing device for processing rather than writing the check by hand.

One issue with entering check information is how easy it is to make mistakes when such an entry requires correct entry of two long strings of numbers. Such mistakes may serve as a barrier to completing the transaction using the computing device, or may remain undetected until a later point, when corrective action may be required of the user of the computing device. In order to avoid such corrective action, it may be desirable to detect incorrectly entered account numbers before a transaction is completed.

However, electronic means of performing account number-based transactions (e.g., ACH transactions) do not have any inherent ability to verify account details, such as routing and account numbers. The few existing methods to detect incorrectly entered account numbers are generally inadequate solutions. For example, some banks may provide hotlines to call in order verify account numbers, but this may not be available for all banks. Further, it is impractical to call a phone number each time an account number needs verification when performing a large number of transactions. As another example, the Federal Reserve provides a routing number search engine. However, this search engine, as the name implies, is only available for routing numbers and cannot be used to verify account numbers.

Thus, systems and methods are needed to identify incorrectly entered account numbers that avoid the impracticalities and inefficiencies of existing solutions.

### BRIEF SUMMARY

Certain embodiments provide a method for identifying incorrect account numbers using machine learning. The method includes receiving, over a network from a user device, a transaction including an account number and providing the account number to a machine learning model. The method further includes obtaining output from the machine learning model including a confidence score for the account number and transmitting, over the network to the user device, the confidence score. The method further includes receiving, over the network from the user device, a response to transmitting the confidence score and processing the transaction based on the response. The method further includes updating a transaction database based on success or failure of the transaction.

Another embodiment provides a computing device comprising a memory including computer executable instructions and a processor configured to execute the computer executable instructions and cause the computing device to perform the method for identifying incorrect account numbers using machine learning described above. Still another embodiment provides a non-transitory computer readable medium comprising instructions to be executed in a computer system, wherein the instructions when executed in the computer system perform the method for identifying incorrect account numbers using machine learning described above.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 is a block diagram of an example computing environment in which embodiments described herein may operate.

FIG. 2 is a conceptual illustration of the analysis of various account number features.

FIG. 3 is a call-flow diagram of an example method to identify incorrect account numbers.

FIG. 4 is a flow diagram of an example method to identify incorrect account numbers.

FIG. 5 is an example computing device configured to perform methods in accordance with embodiments described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for identifying incorrectly entered account numbers using machine learning pattern recognition.

In order to more accurately and more efficiently identify incorrect account numbers compared to conventional methods, machine learning systems may be employed. In general, by utilizing a transaction database including account numbers, various features of account numbers may be recognized and used to categorize other newly received account numbers. For example, if an account number is part of an Automated Clearing House (ACH) number combination, the account number is preceded by a routing number. The routing number corresponds to a particular number issuing authority (such as a bank or other financial institution). The routing number may be used to identify the account number as associated with a particular number issuing authority, which, once known, may be used to determine if the account number is a valid number for the particular numbering issuing authority.

Various features of account numbers for the particular number issuing authority may be identified based on known account numbers from the number issuing authority found in the transaction database. These known account numbers may be used to train a machine learning model. The machine learning model can thereafter recognize features of the known account numbers, and can search for such features in a newly obtained account number in order to predict whether the newly obtained account number is incorrect. Output of the machine learning model when performing such a prediction includes a confidence score, which is a metric indicating confidence in the correctness of the newly obtained account number.

For example, a user device may send a transaction to a server so that the server can process the transaction. The server may identify and extract an account number from the transaction and provide the account number to the machine learning model. The server may then obtain output of the machine learning model, including a confidence score. The server may then process the transaction based on the confidence score, or may transmit the confidence score to the user device. The confidence score may be transmitted to obtain further information related to the account number (such as a verification of the account number) or to request permission to proceed with the transaction (e.g., a confirmation of the transaction). Based on a response to the transmission of the confidence score, the server may process the transaction. After processing (or attempting to process) the transaction, the server may update the transaction database based on success or failure of the transaction. Such updating may be used to perform additional identification of subsequent account numbers received by the server.

Use of the methods described herein enable incorrect account numbers to be identified with greater speed and efficiency than is possible with existing methods. Further, use of the present disclosure enables account numbers to be verified in a transactional system of large size, while existing methods are inadequate to employ in such systems as existing methods have a significant cost in time on a per-transaction basis. This increased efficiency in processing time also allows transactions to be processed more quickly, thus providing more certainty to organizations using electronic transaction systems as less time is spent waiting for transactions to process. Thus, effective automation of identifying incorrect account numbers such as described herein allows electronic transactions system to be brought to a large number of users. Use of automatic account number identification also enables a faster transaction experience for users. Further, the systems and methods of the present disclosure may enable electronic transaction systems that produce fewer errors (e.g., failed transactions due to incorrect numbers) than is currently possible.

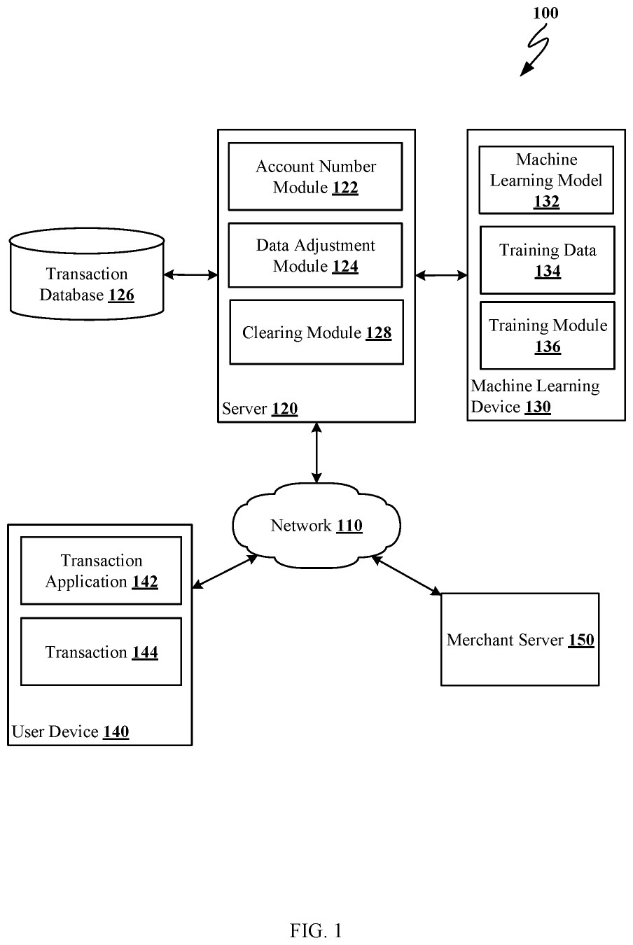

FIG. 1 is a block diagram of an example computing environment 100 in which methods described herein may operate. Example computing environment 100 includes server 120, transaction database 126, machine learning device 130, user device 140 and merchant server 150, all connected via network 110. Although shown separately from server 120, in other embodiments transaction database 126 and machine learning device 130 may be implemented as components of server 120, or the functions of transaction database 126 and machine learning device 130 may be performed by server 120. Additionally, though transaction database 126 and machine learning device 130 are shown connected directly to server 120, in other embodiments transaction database 126 and machine learning device 130 may be available to server 120 over network 110, which may include a wide area network (WAN), local area network (LAN) or other type of network connection.

Server 120 is a computing device that includes account number module 122, data adjustment module 124 and clearing module 128. Account number module 122 is an application or utility executing on server 120 that obtains data obtained from transaction database 126 and sends the data to training module 136 of machine learning device 130. Training module 136 uses the data to train machine learning model 132. Transaction database 126 is a record of previous transactions processed through server 120, or processed by other servers within a transaction processing system. The record of previous transactions includes information about the previous transactions, including, for example, an account combination, of an account number and a routing number, used in the transaction and a success designation for the transaction (e.g., success or failure). This information (account numbers and success designations) can be used to train machine learning model 132.

Because failed transactions may be relatively underrepresented in transaction database 126, account number module 122 may use data adjustment module 124 to produce adjusted data, which has an increased prevalence of failed transactions. Various sampling techniques are available to balance datasets that have a small number of uncommon occurrences and a large number of common occurrences. Such sampling techniques including synthetic minority oversampling technique (SMOTE) and adaptive synthetic sampling approach for imbalanced learning (ADASYN). In the current example, failed transactions are rare events, so the use of sampling techniques allows the adjusted data to include a larger percentage of failed transactions than is likely to occur naturally (e.g., an increased prevalence). Data adjustment module 124 may also perform various other tasks to the obtained transaction data to improve the quality of the adjusted data. Such other tasks may include clean-up of the transaction data to remove or correct erroneous data. Other tasks may also include sanitizing the transaction data to remove personal user information. Data adjustment module 124 may also perform featurization on the transaction data.

After the adjusted data is produced, account number module 122 provides the adjusted data to training module 136 executing on machine learning device 130 for training. The adjusted data may then be stored as or alongside training data 134. Machine learning device 130 is a computing device used to train and execute machine learning model 132. Machine learning model 132 may be any of a variety of machine learning models or algorithms, including tree-based machine learning models such as a classification and regression tree (CART), a random forest model or XGBoost. Other possible machine learning models than can be used as machine learning model 132 include neural networks, recurrent neural networks (RNN), long short-term memory (LSTM) models, support vector machines (SVM), or logistic regression models.

Clearing module 128 is an application or utility executing on server 120 that processes (e.g., clears) transactions as part of an electronic transaction system. Clearing module 128 may also be able to determine, based on a confidence score produced by machine learning model 132, whether or not to process a transaction including an account number associated with the confidence score.

Generally, training a machine learning model, such as machine learning model 132, comprises approximately five steps. First, a set of data is separated into training data and test data. Second, the training data is used to train the machine learning model. Next, the machine learning model is given the test data as input and produces output based on the test data. Fourth, a model optimizer analyzes the output compared to a set of parameters used to define the model, and determines changes to the set of parameters that would produce better (e.g., more accurate) output for the test data. Fifth, and finally, the machine learning model is updated based on the determined changes. The five steps may be repeated (e.g., iteratively) until training is complete. For example, if on repeated iterations of the five steps any improvement in the output is reduced to an insignificant change, training may be ceased. As another example, training may continue until one or more performance metrics is met.

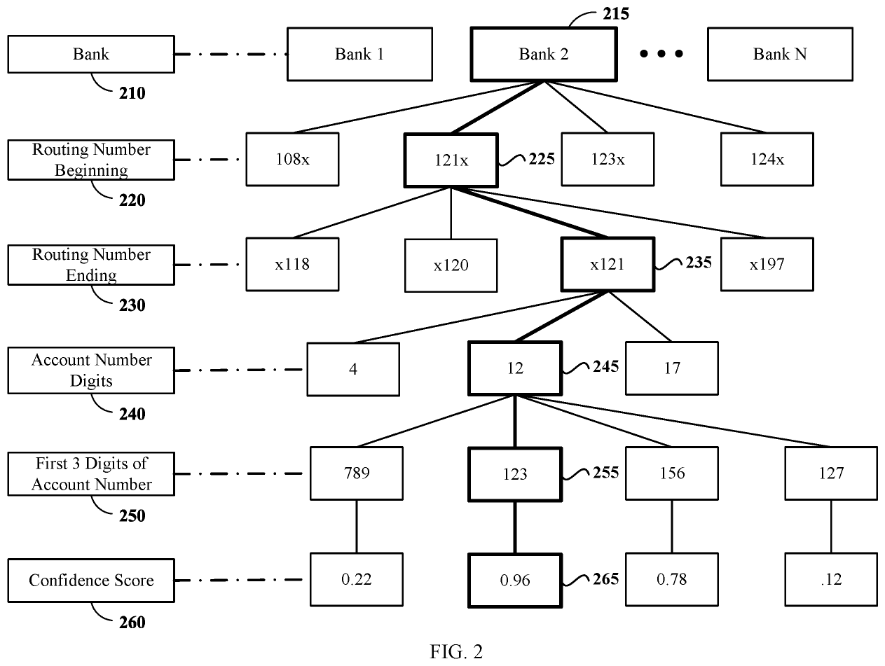

In this example, the adjusted data is provided to training module 136 as training data 134, and is used to train machine learning model 132. After training of machine learning model 132 is complete, machine learning model 132 is capable of predicting an incorrect account number received as a part of a transaction. In particular, as described in further detail below with respect to FIG. 2, various features of the account number may be assessed and compared to features known by machine learning model 132.

Server 120 also receives transactions initiated by user device 140, such as transaction 144. Communication between server 120 and user device 140 may be facilitated by transaction application 142 executing on user device 140. In this example transaction application 142 is a dedicated application executing on the hardware of user device 140. However, in other embodiments, the functions of transaction application 142 may be performed by a multi-purpose application capable of performing other tasks, or user device 140 may communicate with server 120 using a web browsing application.

In this example, user device 140 initiates a transaction across network 110 with merchant server 150, shown as transaction 144. Transaction 144 may be initiated by transaction application 142 or by a separate application or utility executing on user device 140. Transaction 144 is thereafter transmitted to server 120 for processing.

After server 120 receives transaction 144, account number module 122 begins processing transaction 144. Account number module 122 extracts an account combination from transaction 144. The account combination may be an ACH account combination comprising a routing number and an account number. Account number module 122 passes both the routing number and the account number for analysis to machine learning model 132.

Machine learning model 132 may be used to identify a number issuing authority associated with the account number, based on the routing number (e.g., when given a routing number as input, machine learning model 132 outputs an associated number issuing authority). Machine learning model 132 may then be used to analyze the account number based on known features of other account numbers associated with the number issuing authority. That is, given an account number as input, machine learning model 132 produces output of a confidence score for the account number. The confidence score represents a metric (e.g., a percentage or a scaled value) of confidence that the account number is correct (e.g., a valid account number for the number issuing authority).

Machine learning model 132 then provides the confidence score to account number module 122. If the confidence score is above a certain threshold, clearing module 128 may process the transaction. Otherwise, account number module 122 may transmit the confidence score to user device 140 requesting a confirmation of the account number. Based on a response from user device 140 to this transmission, clearing module 128 determines whether to process the transaction or not. If account number module 122 determines to process the transaction, clearing module 128 completes the processing. Based on the success or failure of the transaction, clearing module 128 then updates transaction database 126. Machine learning model 132 may thereafter be re-trained based on the update to transaction database 126 because the known success or failure of the transaction becomes a ground-truth transaction that can be used for training.

In some embodiments, in addition to transmitting the confidence score to user device 140, account number module 122 may request a verification of the account number (or the account combination) from user device 140. For example, if the account number is associated with a bank, the verification may include an image of a bank statement or a check associated with the account number. User device 140 may obtain a photograph of the bank statement or the check from a camera of user device 140. In other embodiments user device 140 may use a scanner or other appliance to obtain images of the bank statement or the check. Account number module 122 may then examine the verification and update machine learning model 132 accordingly. For example, if machine learning model 132 produced a low confidence score for a given account number but a received verification demonstrates the given account number is correct, machine learning model 132 may be adjusted to account for the pattern present in the given account number. For example, the given account number can be added to training data used to train machine learning model 132. If that training data is used to retrain machine learning model 132, machine learning model 132 will then be able to more accurately calculate confidence scores for numbers following the pattern of the given account number. Examination of the verification may be performed by an optical character recognition (OCR) process, or by a dedicated human agent for examining such verifications.

In other embodiments, account number module 122 may also receive user feedback along with the response from user device 140. This user feedback may also be used to update or modify machine learning model 132. As above, an account number associated with the feedback may be added to the training data as a correct account number, and machine learning model 132 may be re-trained. In other examples, verification rules may be used to override the confidence score produced by machine learning model 132 (e.g., the confidence score is increased based on user feedback). For example, user feedback may include an assertion of correctness of the account number. If account number module 122 receives feedback indicating an account number marked with a low confidence score is in fact correct, machine learning model 132 may be adjusted or retrained to account for features present in the account number.

Account number module 122 may also be able to determine that a particular number issuing authority has started use of a new number pattern for account numbers. If so, the new number pattern may be accounted for in identifying incorrect numbers (e.g., account numbers following the new number pattern are likely correct). As a result, account number module 122 may provide data to train machine learning model 132 using the use new number pattern.

FIG. 2 is a conceptual illustration of the analysis of various account number features, according to one embodiment of the present disclosure. FIG. 2 may represent the internal logic of a machine learning model used to evaluate account numbers, such as machine learning model 132 of FIG. 1. In FIG. 2, the machine learning model is a tree-based model, and an account number combination comprising a routing number and an account number is analyzed by the tree-based model. The routing number in this example is “121121121” and the account number in this example is “123456789012.” Routing numbers are nine digits long, while account numbers may be arbitrarily long for a given number issuing authority (e.g., a bank).

In this example, the analysis of an account number includes five features. First, a number issuing authority (illustrated here for simplicity as a bank) is identified at level 210. In this example, bank 2 is identified as associated with the account number at box 215. This identification is based on the routing number. Routing numbers are associated with certain number issuing authorities and are not specific to individual account numbers. Therefore, a table or other data structure pairing routing numbers to number issuing authorities may be utilized to perform the identification at box 215.

Next, at level 220 a beginning of a routing number paired with the account number is identified. Although, as previously mentioned, a routing number is associated with a single number issuing authority, the number issuing authority may be associated with a plurality of routing numbers. For example, a bank may have a different routing number for every branch of the bank or for different regions of a bank, etc. Level 220 narrows down the field of routing numbers associated with bank 2. Level 220 includes four different routing number beginnings (or prefixes) for routing numbers of bank 2: “108x,” “121x,” “123x” and “124x.” In this example, because the routing number starts with “121”, the routing number is identified as a “121x” routing number at box 225.

At level 230 the end of the routing number is identified. Level 230 shows possible ending sequences for routing numbers of bank 2 that begin with “121,” which include “x118,” “x120,” “x121” and “x197. In this example, because the routing number ends with “121”, the routing number is identified as an “x121” routing number at box 235.

Then, at level 240 the number of digits of the account number is assessed. Level 240 shows all possible account number digit lengths for account numbers associated with routing numbers of bank 2 that begin with “121” and end with “121.” In general, a set of most frequently valid account number lengths for the routing number are determined. There are three most likely account number digit lengths at level 240: four digits, twelve digits and seventeen digits. Because the account number has twelve digits total, the account number is identified as such at box 245.

At level 250, the first three digits of the account number are analyzed. In this example, three digits are used, but prefixes of account numbers of different sizes may also be used. In this example, four account number prefixes are accounted for: “789,” “123,” “156” and “127.” Afterwards, at level 260 a confidence score is produced based on the account number prefix. As shown, account numbers beginning with “789” produce a confidence score of 0.22, account numbers beginning with “123” produce a confidence score of 0.96, account numbers beginning with “156” produce a confidence score of 0.78, account numbers beginning with “127” produce a confidence score of 0.12. In general, these confidence scores represent likelihood that the account number is correct. Because the account number in this example begins with “123,” the account number is identified, at box 255 as such. Consequently, the account number in this example produces a confidence score of 0.96, as indicated at box 265.

In total, FIG. 2 shows possible confidence scores for four account number combinations. For example any combination following the pattern “121xxx121.123xxxxxxxxx” (where the period separates the routing number from the account number) produces a confidence score of 0.96, which indicates high confidence that “123xxxxxxxxx” is a correct account number for bank 2. On the other hand any combination following the pattern “121xxx121.127xxxxxxxxx” produces a confidence score of 0.12, which indicates low confidence that “127xxxxxxxxx” is a correct account number for bank 2. The confidence score, when produced, is provided to a transaction server, such as server 120 of FIG. 1, for use in processing transactions.

FIG. 2 presents the analysis of a single pattern of account combinations. Not all evaluations involve precisely the same steps, but, in general, numbers are evaluated for the features shown. That is, a number issuing authority (such as a bank) is identified based on the routing number. The beginning of the routing number as well as the ending of the routing number are analyzed. The number of digits and a prefix for the account number are also analyzed. Collectively, these prefixes and characteristics of the numbers may be called features. Other features may also be analyzed as part of identifying incorrect account numbers, and the sequence of features analyzed may also be changed.

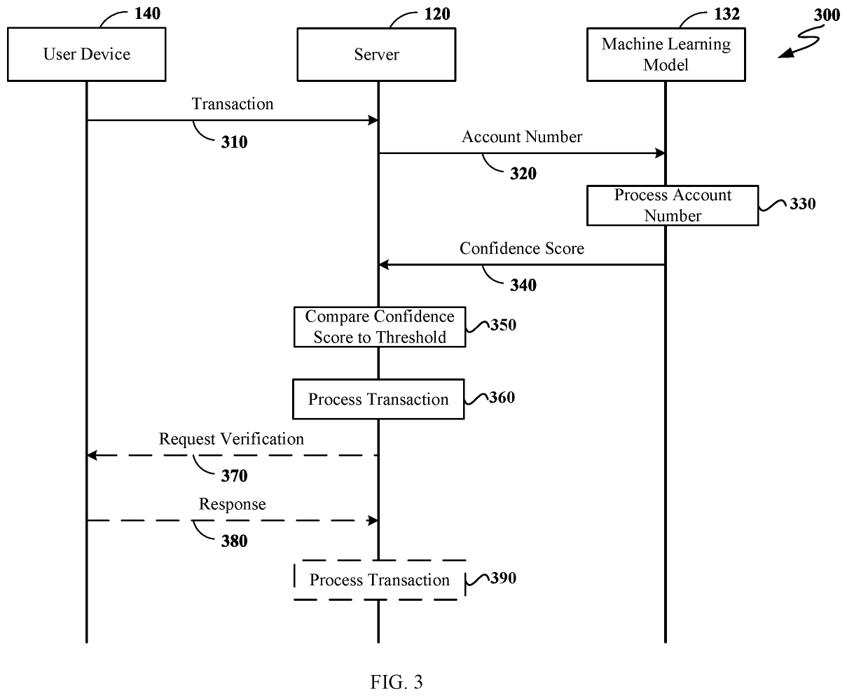

FIG. 3 is a call-flow diagram of an example method 300 to identify incorrect account numbers. Method 300 involves user device 140, server 120 and machine learning model 132. Method 300 starts at transmission 310, where user device 140 transmits a transaction to server 120. The transaction may have been initiated by user device 140 as part of an online purchase or other money transfer. If user device 140 is a mobile device, the transaction may also have been initiated by user device 140 during an in-person or physical purchase or money transfer.

At transmission 320, server 120 sends an account number extracted from the transaction to machine learning model 132. The data sent in transmission 320 serves as input to machine learning model 132. The account number may be sent along with a routing number, paired together as an account combination. In some embodiments, the account number is part of an automated clearing house (ACH) account number comprising a routing number and the account number.

At block 330 machine learning model 132 processes the account number. As described in further detail above with respect to FIG. 2, processing the account number includes establishing a confidence score for the account number based on features of the account number compared to other known account numbers of the number issuing authority. In some embodiments of method 400, the machine learning model is one of a tree-based machine learning model, a neural network, a long short-term memory (LSTM) model, a recurrent neural network (RNN), a support vector machine (SVM) and a logistic regression model.

At transmission 340, machine learning model 132 sends the confidence score to server 120. In this example, server 120 compares the confidence score to a threshold at box 350. Then, if the confidence score exceeds the threshold, server 120 processes the transaction at box 360.

As an alternative to boxes 350 and 360, server 120 may, at transmission 370, transmit a request for verification to user device 140. This may be performed, if at, box 350, the confidence score is determined to be below the threshold. Transmission 370 may include, along with the request to verify the account number, a presentation of the confidence score for view. Further, transmission 370 may include a request to confirm the transaction.

At transmission 380, user device 140 transmits a response to transmission 370 to server 120. The response includes a verification of the account number or a confirmation of the transaction as discussed above. In this example, a user of user device 140 has confirmed the transaction and so, at block 390, the transaction is processed. In other examples, if the user did not confirm the transaction, or did not verify the account number, account number module 122 would not process the transaction.

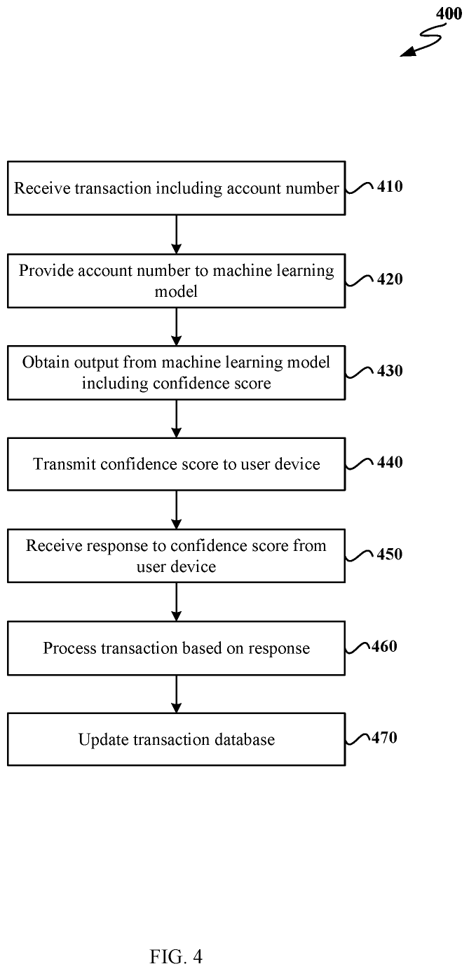

FIG. 4 is a flow diagram of an example method 400 to predict incorrect account numbers. Method 400 may be performed by instructions executing on a processor of a server (such as server 120 of FIG. 1) and include the functions of an account number module (such as account number module 122 of FIG. 1).

Method 400 begins at block 410, where the server receives, over a network from a user device, a transaction including an account number. The transaction may have been initiated by the user device in communication with a third computing device or may have been initiated by the user device while in proximity to a physical point of sale device. In either event, the transaction is transmitted to the server for processing. Processing in this sense means a clearing of the transaction through the related financial accounts and institutions to facilitate the transfer of money associated with the transaction. For example, if a user makes a purchase online using a bank account, the server may process the purchase by withdrawing funds from the bank account to complete the purchase. However, before processing the server may attempt to identify an incorrect account number in the transaction using method 400.

Method 400 then proceeds to block 420, where the server provides the account number to a machine learning model. Prior to block 420, the machine learning model may have been trained using other account numbers previously processed by the server. In general, the account number module provides the account number to the machine learning model so that the machine learning model may predict whether the account number is correct or not. As described in further detail with respect to FIG. 2 above, the machine learning model analyzes the account number and produces a confidence score for the account number.

Method 400 then proceeds to block 430, where the server obtains output from the machine learning model including the confidence score. The confidence score represents a likelihood that the account number received from the user device is correct. For example, a correct bank account number is a valid account number issued by the bank. The confidence score may represent a likelihood, based on other account numbers of that bank, that the current account number is valid.

Method 400 then proceeds to block 440, where the server transmits, over the network to the user device, the confidence score. This transmission may include a request to confirm the transaction. For example, the server may cause a graphical user interface (GUI) to be displayed on the user device requesting confirmation. This request may be a question posed to the user, such as “Are you sure you entered your account number correctly?” The transmission to the user device may also include a request to verify the account, such as by providing documentation. For example, the server may cause a GUI to display on the user device which requests a photograph of the user's bank statement or a photograph of a check associated with the account. In some examples, the server may determine the confidence score exceeds a given threshold, and as a result process the transaction without additional transmissions to the user device.

Method 400 then proceeds to block 450, where the server receives, over the network from the user device, a response to transmitting the confidence score. As discussed above, the transmission to the user device may include a request for confirmation of the transaction or a request for verification of the account number. If so, the response includes information responsive to the requests. For example, if the server requested verification of the account, the response may include a photograph of a bank statement. If a photograph is included the server may use an OCR process to process the photograph and verify the account number. If the account number listed on the verification is the same as originally transmitted, the server may update the machine learning model in order to account for the features of the account number. In other examples, the server may receive a response to a request to verify the account number, as discussed above.

Method 400 then proceeds to block 460, where the server processes the transaction based on the response. In general, if the response is to a request to the confirm the transaction, the response may include instructions to proceed with the transaction or instructions to stop the transaction. In this example, the server receives instructions to proceeds and so processes the transaction.

Method 400 then proceeds to block 470, where the server updates a transaction database based on success or failure of the transaction. In general, the transaction database includes information that, after adjustment, may be used to train or re-train the machine learning model. As a result, the transaction database should be kept up to date to improve the accuracy of subsequent identifications by the machine learning model. For example, if the transaction succeeds but the machine learning model assigned a low confidence score to the account number, the update to the transaction database may improve the quality of confidence scores of account numbers similar to the account number. In particular, after being re-trained, the machine learning model may assign higher confidence scores to account numbers similar to the account number.

Though not depicted in FIG. 4, in other embodiments method 400 may further include delaying processing the transaction based on the confidence score.

In other embodiments, method 400 may further include prior to receiving the transaction, obtaining, from the transaction database, transactions, including successful transactions and failed transactions and increasing a prevalence of failed transactions among the transaction using a sampling technique to produce adjusted data. Thereafter, method 400 may include training the machine learning model using the adjusted data. In still other embodiment, the sampling technique is one of Synthetic Minority Oversampling Technique (SMOTE); and Adaptive Synthetic Sampling Approach for Imbalanced Learning (ADASYN).

In other embodiments, method 400 may further include determining the response to transmitting the confidence score includes user feedback associated with the account number and training the machine learning model using the user feedback.

In other embodiments, method 400 may further include determining the transaction has failed and requesting, from the user device, a verification of the account number. Thereafter, method 400 may include training the machine learning model using the verification.

In other embodiments, method 400 may further include determining a new number pattern in use by a number issuing authority and training the machine learning model using the new number pattern.

In other embodiments, method 400 may further include identifying a number issuing authority of the account number based on the routing number.

In some embodiments of method 400, the machine learning model determines at least one of: a bank associated with the account number, a routing number associated with the bank, a length of the account number, a beginning of the account number, a final digit of the account number, an account number prefix comprising at least three digits and a set of most frequently valid account number lengths for the routing number.

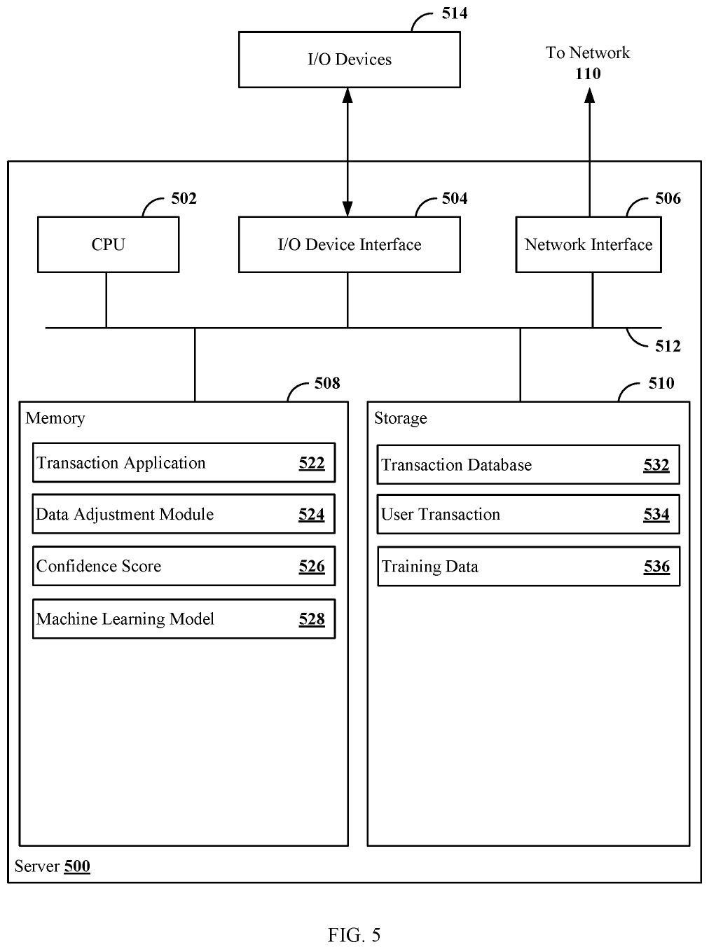

FIG. 5 is depicts an example server 500, such as server 120 of FIG. 1. As shown, the server 500 includes, without limitation, a central processing unit (CPU) 502, one or more input/output (I/O) device interfaces 504, which may allow for the connection of various I/O devices 514 (e.g., keyboards, displays, mouse devices, pen input, etc.) to server 500, network interface 506, memory 508, storage 510, and an interconnect 512.

The CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, memory 508, and storage 510. The CPU 502 is included to be representative of a single CPU, multiple CPUs, a single CPU having multiple processing cores, and the like. The I/O device interface 504 may provide an interface for capturing data from one or more input devices integrated into or connected to the server 500, such as keyboards, mice, touchscreens, and so on. The memory 508 may represent a random access memory (RAM), while the storage 510 may be a solid state drive, for example. Although shown as a single unit, the storage 510 may be a combination of fixed and/or removable storage devices, such as fixed drives, removable memory cards, network attached storage (NAS), or cloud-based storage.

As shown, the memory 508 includes transaction application 522, data adjustment module 524, confidence score 526 and machine learning model 528. Transaction application 522 communicates with a user device via network 105 and network interface 506, and receives user transaction 534 from the user device. Data adjustment module 524 uses information obtained from transaction database 532 to generate adjusted data for training a machine learning model. Confidence score 526 is the output of the machine learning model after evaluating an account number. Transaction application 522 transmits confidence score 526 to the user device. Transaction application 522 and data adjustment module 524 may be applications executed based on instructions stored in the storage 510. Such instructions may be executed by the CPU 502. Confidence score 526 is a data structure temporarily resident in memory 508.

Machine learning model 528 is used to generate confidence score 526. Before use, machine learning model 528 may be trained using training data 536. Machine learning model 528 is shown in this example as resident on server 500, but in other examples, machine learning model 528 and training data 536 may be resident on a different server, such as a server or other computing device that is specifically designed for the computationally intensive process of training machine learning model 528.

As shown, the storage 510 includes transaction database 532, user transaction 534 and training data 536. Transaction database 532 is a data store of transactions previously processed by server 500. User transaction is a new transaction received from the user device (via transaction application 522) to be evaluated by the machine learning model.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other circuit elements that are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for identifying incorrect account numbers using a machine learning model, comprising:
receiving, from a user device, a transaction including an account number;
providing the account number to a machine learning model that has been trained based on successes or failures of previous transactions associated with particular account numbers, wherein the machine learning model comprises one or more of:
a tree-based machine learning model; or
a support vector machine (SVM);
obtaining output from the machine learning model including a confidence score for the account number;
transmitting, to the user device, the confidence score;
receiving, from the user device, a response to transmitting the confidence score;
processing the transaction based on the response; and
updating a transaction database based on a success or a failure of the transaction.

2. The method of claim 1, further comprising, prior to receiving the transaction:
obtaining, from the transaction database, prior transactions, including successful transactions and failed transactions;
using a sampling technique to produce adjusted data in which a prevalence of failed transactions is increased among the prior transactions; and
training the machine learning model using the adjusted data.

3. The method of claim 2, wherein the sampling technique is one of:
a Synthetic Minority Oversampling Technique (SMOTE); or
an Adaptive Synthetic Sampling Approach for Imbalanced Learning (ADASYN) technique.

4. The method of claim 1, further comprising receiving, from the user device, a routing number associated with the transaction, wherein the routing number is provided with the account number to the machine learning model.

5. The method of claim 4, wherein the output from the machine learning model is based on the routing number and the account number.

6. The method of claim 1, wherein the output from the machine learning model is based on at least one of:
a bank associated with the account number;
a length of the account number;
a beginning of the account number;
a final digit of the account number;
an account number prefix comprising at least three digits; or
a set of most frequently valid account number lengths for a routing number associated with the bank.

7. The method of claim 1, wherein the response comprises a photograph of a bank statement.

8. A system for identifying incorrect account numbers using machine learning, the system comprising:
one or more processors; and
a memory comprising instructions that, when executed by the one or more processors, cause the system to:
receive, over a network from a user device, a transaction including an account number;
provide the account number to a machine learning model that has been trained based on successes or failures of previous transactions associated with particular account numbers, wherein the machine learning model comprises one or more of:
a tree-based machine learning model; or
a support vector machine (SVM);
obtain output from the machine learning model including a confidence score for the account number;
transmit, over the network to the user device, the confidence score;
receive, over the network from the user device, a response to transmitting the confidence score;
process the transaction based on the response; and
update a transaction database based on a success or a failure of the transaction.

9. The system of claim 8, wherein the instructions, when executed by the one or more processors, further cause the system to, prior to receiving the transaction:
obtain, from the transaction database, prior transactions, including successful transactions and failed transactions;
using a sampling technique to produce adjusted data in which a prevalence of failed transactions is increased among the prior transactions; and
train the machine learning model using the adjusted data.

10. The system of claim 9, wherein the sampling technique is one of:
a Synthetic Minority Oversampling Technique (SMOTE); or
an Adaptive Synthetic Sampling Approach for Imbalanced Learning (ADASYN) technique.

11. The system of claim 8, wherein the instructions, when executed by the one or more processors, further cause the system to receive, from the user device, a routing number associated with the transaction, wherein the routing number is provided with the account number to the machine learning model.

12. The system of claim 11, wherein the output from the machine learning model is based on the routing number and the account number.

13. The system of claim 8, wherein the output from the machine learning model is based on at least one of:
a bank associated with the account number;
a length of the account number;
a beginning of the account number;
a final digit of the account number;
an account number prefix comprising at least three digits; or
a set of most frequently valid account number lengths for a routing number associated with the bank.

14. The system of claim 8, wherein the response comprises a photograph of a bank statement.

15. A method for identifying incorrect account numbers using machine learning, comprising:
receiving, over a network from a user device, a transaction including an account number;
providing the account number to a machine learning model that has been trained based on successes or failures of previous transactions associated with particular account numbers, wherein the machine learning model comprises one or more of:
a tree-based machine learning model; or
a support vector machine (SVM);
obtaining output from the machine learning model including a confidence score for the account number;
transmitting, over the network to the user device, the confidence score;
receiving, over the network from the user device, a response to transmitting the confidence score, wherein the response comprises a verification of the account number or a confirmation of the transaction;
processing the transaction based on the response; and
updating a transaction database based on a success or a failure of the transaction.

16. The method of claim 15, further comprising, prior to receiving the transaction:
obtaining, from the transaction database, prior transactions, including successful transactions and failed transactions;
using a sampling technique to produce adjusted data in which a prevalence of failed transactions is increased among the prior transactions; and
training the machine learning model using the adjusted data.

17. The method of claim 16, wherein the sampling technique is one of:
a Synthetic Minority Oversampling Technique (SMOTE); or
an Adaptive Synthetic Sampling Approach for Imbalanced Learning (ADASYN) technique.

18. The method of claim 15, further comprising receiving, from the user device, a routing number associated with the transaction, wherein the routing number is provided with the account number to the machine learning model.

19. The method of claim 18, wherein the output from the machine learning model is based on the routing number and the account number.

20. The method of claim 15, wherein the output from the machine learning model is based on at least one of:
a bank associated with the account number;
a length of the account number;
a beginning of the account number;
a final digit of the account number;
an account number prefix comprising at least three digits; or
a set of most frequently valid account number lengths for a routing number associated with the bank.
